(19) United States
(12) Patent Application Publication
(10) Pub. No.: US 2014/0268781 A1
(43) Pub. Date: Sep. 18, 2014

(54) Modular LED (Light Emitting Diode) Lighting System and Method of Assembling Same

(71) Applicant: Spire Manufacturing, Inc., Fremont, CA (US)

(72) Inventors: Hai Dau, San Ramon, CA (US); Jingnesh Patel, Sunnyvale, CA (US); Jaspreet Singh, San Jose, CA (US)

(73) Assignee: Spire Manufacturing, Inc., Fremont, CA (US)

(21) Appl. No.: 13/841,661

(22) Filed: Mar. 15, 2013

(51) Int. Cl. F21S 4/00

(52) U.S. Cl. CPC F21S 4/003
USPC 362/249.06; 29/592.1

(57) ABSTRACT

In one embodiment, the present invention includes a lighting system. The lighting system comprises a light fixture. The light fixture includes a plurality of light emitting diode (LED) strings and a housing. The plurality of LED strings are electrically coupled in a low voltage configuration. The housing has the plurality of LED strings disposed in the direction of a longitudinal axis of the housing and includes a first and second member. The first member protrudes from a first end of the housing and has a first set of conductive elements electrically coupled across the plurality of LED strings. The second member protrudes from a second end of the housing and has a second set of conductive elements electrically coupled across the plurality of LED strings. The first and second members are complimentary to provide mechanical and electrical coupling between the light fixture and other fixtures without external wiring.

### CROSS REFERENCE TO RELATED APPLICATIONS

Not applicable.

### BACKGROUND

The present invention relates to lighting fixtures, and in particular, to modular LED lighting systems and methods of assembling same.

### SUMMARY

Embodiments of the present invention include a lighting system. The lighting system comprises a light fixture. The light fixture includes a plurality of light emitting diode (LED) strings and a housing. The plurality of LED strings are electrically coupled in a low voltage configuration. The housing has the plurality of LED strings disposed in the direction of a longitudinal axis of the housing and includes a first and second member. The first member protrudes from a first end of the housing and has a first set of conductive elements electrically coupled across the plurality of LED strings. The second member protrudes from a second end of the housing and has a second set of conductive elements electrically coupled across the plurality of LED strings. The first and second members are complimentary to provide mechanical and electrical coupling between the light fixture and other fixtures without external wiring.

Embodiments of the present invention include a light fixture. The light fixture comprises a housing, a set of conductive actuators, a set of conductive surfaces, and a plurality of LED strings. The set of conductive actuators is integrated into a first end of the housing. The set of conductive surfaces is integrated into a second end of the housing. The plurality of LED strings is disposed within the housing and electrically coupled to the set of conductive actuators and the set of conductive surfaces. The set of conductive actuators is complimentary to the set of conductive surfaces such that a plurality of light fixtures, each identical to the light fixture, may be affixed end to end with the light fixture to provide a continuous electrical connection to illuminate the plurality of LED strings and a plurality of LED strings of each light fixture of the plurality of light fixtures.

The following detailed description and accompanying drawings provide a better understanding of the nature and advantages of the present invention.

### BRIEF DESCRIPTION OF THE DRAWINGS

FIG. 1 illustrates block diagram of a modular lighting system according to one embodiment of the present invention.

FIG. 2 illustrates a schematic of a low voltage configuration of a plurality of LED strings according to one embodiment of the present invention.

FIG. 3A illustrates a top view with a cut away view of a light fixture according to one embodiment of the present invention.

FIG. 3B illustrates one end of a light fixture according to one embodiment of the present invention.

FIG. 3C illustrates another end of a light fixture according to one embodiment of the present invention.

FIG. 3D illustrates an assembly of two ends of two modular light fixtures according to one embodiment of the present invention.

### DETAILED DESCRIPTION

Described herein are techniques for modular lighting systems and method of assembling same. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

FIG. 1 illustrates block diagram of a modular lighting system 100 according to one embodiment of the present invention. Modular lighting system 100 includes an alternating current (AC) power source 101, a power module 102, and lighting fixtures 103-104. Lighting system 100 provides lighting through serially connected modules.

AC power source 101 provides power to light fixtures 103-104 through modules 102a and 102b. Module 102a includes direct current (DC) power supply 105 which receives a single line from AC power source 101 and distributes power to two independent circuits of light fixtures 103-104. Module 102b couples DC power electrically from power supply 105 to lighting fixture 103 through conductive elements 119-120 and 107-108. Power supply 105 includes a plurality of DC supplies 106 which work in concert to provide DC power to lighting fixture 103 and 104. Power supply 105 may interactively adjust power based on the number of lighting fixtures coupled in series (e.g. fixture 103 and 104). In one embodiment, modules 102a and 102b are integrated together such that only a single cable (having two conductive wires) is required to power lighting fixtures 103 and 104. Implementation of this embodiment may depend on the weight of power supply 105. In this embodiment, conductive elements 107 and 108 are conductive actuators and conductive elements 119-120 are conductive surfaces.

Lighting fixture 103 includes conductive elements 107-108, 111-112, and light emitting diode (LED) strings 109-110. DC power supply 105 couples through conductive element 119 and 107 to power LED strings 109. DC power supply 105 couples through conductive element 120 and 108 to power LED strings 110. Light fixture 103 couples electrically to lighting fixture 104 through conductive elements 111-114.

Lighting fixture 104 includes conductive elements 113-114, 117-118, and light emitting diode (LED) strings 115-116. DC power supply 105 couples through conductive element 119, 107, 111, and 113 to power LED strings 115. DC power supply 106 couples through conductive element 120, 108, 112, and 114 to power LED strings 116. Light fixture 104 couples electrically to other lighting fixtures through conductive elements 117-118. LED strings 109 and 115 are electrically isolated from LED strings 110 and 116 to increase the likelihood of continuous light upon partial electrical failure or partially interrupted power from DC power supply 105 or 106.

FIG. 2 illustrates a schematic of a low voltage configuration of a plurality of LED strings 200 according to one embodiment of the present invention. A plurality of LED strings 202, 203, 204, . . . and 206 are coupled in parallel and powered by DC power supply 201. The indicator 205 denotes that several LED strings may be coupled together. In one embodiment ten LED strings are coupled together in one circuit of one lighting fixture. This DC power supply 201 may be from a module similar to DC power supplies 105-106 of FIG. 1. In this embodiment, each LED string has eight LEDs coupled in series. In one embodiment each circuit has ten LED strings. The number of LEDs in each string determines the voltage requirement for the circuit while the number of LED strings determines the overall current requirement. The voltage and current need to be limited so that the conductive elements 107-108, 111-112, 113-114, and 117-118 of FIG. 1 do not exceed their rating. In another embodiment, a number of LEDs in each of the LED strings 202-206 is limited such that a voltage across (Vin) the plurality of LED strings 202-206 does not exceed 42V.

FIG. 3A illustrates a top view with a cut away view 313 of a light fixture 300 according to one embodiment of the present invention. Light fixture 300 includes a lens 317, housing sides 309-310, protruding members 318-321, and two plurality of LEDs (partially shown in cut away view 313). Lens 317 may be an optical filter. Member 318 protrudes from end 330 and has conductive elements 302 that are coupled across a first plurality of LED strings (not shown). Member 319 protrudes from end 330 and has conductive elements 303 that are electrically coupled across a plurality of LED strings (partially shown in cut away view 313). Member 320 protrudes from end 331 and has conductive elements underneath (i.e. not shown) that are coupled across the first plurality of LED strings. Member 321 protrudes from end 331 and has conductive elements underneath (i.e. not shown) that are electrically coupled across the second plurality of LED strings. Members 320-321 along with a section between make up laterally symmetrical form 304 stretching most of the lateral width of end 331.

Cut away view 313 includes a portion of the second plurality of LED strings. LED 315 is an example of component placement within housing side 310. The LEDs (e.g. LED 315) may be disposed on a printed circuit board (PCB) 314 and directed to shine into an edge 316 of diffuser (not shown) located just below lens 317. This may illuminate a region between the first and second plurality of LED strings. The light diffuser between the first plurality of LED strings and the second plurality of LED strings may redirect a plurality of light rays toward a normal axis perpendicular to a longitudinal axis 311 and a lateral axis 312. Both the first and second pluralities of LED strings below housing side 309-310 respectively are disposed in the direction of a longitudinal axis 311 of the housing.

Members 318 and 320 are complimentary to provide mechanical and electrical coupling between light fixture 300 and other fixtures without external wiring. Similarly, members 319 and 321 are complimentary to provide mechanical and electrical coupling between light fixture 300 and other fixtures without external wiring. For example, hole 305 and 307 are complimentary to hole 306 and 308 respectively such that each fixture is modular and may be affixed end to end to form a plurality of light fixtures.

FIG. 3B illustrates one end 330 of a light fixture 300 according to one embodiment of the present invention. Light fixture 300 includes a housing (309, 310, and 348), a lens 317 above a light diffuser 322, and protruding members 318-319. Member 318 has a PCB 324 which has a set of conductive surfaces 302, an attachment hole 305, and surfaces 326-327. Member 319 has a PCB 325 which has a set of conductive surfaces 303, an attachment hole 307, and surfaces 328-329. Surfaces 326-327 and 323 are proximate to the set of conductive surfaces 302 such that when light fixture 300 is affixed end to end an entire assembly of a plurality of light fixtures resists movement to yaw and roll about end 330. Surfaces 328-329 and 323 are proximate to the set of conductive surfaces 303 such that when light fixture 300 is affixed end to end an entire assembly of a plurality of light fixtures resists movement to yaw and roll about end 330.

FIG. 3C illustrates another end 332 of a light fixture 300 according to one embodiment of the present invention. Light fixture 300 includes a housing (309, 310, and 348), protruding members 320-321. Member 321 has a PCB 340 which has a set of conductive actuators 334, an attachment hole 308, and surfaces 336-337. Member 320 has a PCB 341 which has a set of conductive actuators 335, an attachment hole 306, and surfaces 338-339. Surfaces 336-337 and 349 are proximate to the set of conductive actuators 334 such that when light fixture 300 is affixed end to end an entire assembly of a plurality of light fixtures resists movement to yaw and roll about end 332. Surfaces 338-339 and 349 are proximate to the set of conductive actuators 335 such that when light fixture 300 is affixed end to end an entire assembly of a plurality of light fixtures resists movement to yaw and roll about end 332. Member 333 may be used to laterally align the set of conductive actuators 334-335. Conductive actuators 334-335 are pogo pins in this embodiment.

Ridge 350 partially circumscribes set of conductive actuators 334 and is mechanically complimentary to a surface 323 of FIG. 3B to provide yaw and pitch fixedness when lighting fixture 300 is coupled to other fixtures. Similarly, ridge 351 partially circumscribes set of conductive actuators 335 and is mechanically complimentary to a surface 323 of FIG. 3B to provide yaw and pitch fixedness when lighting fixture 300 is coupled to other fixtures.

FIG. 3D illustrates an assembly of two ends of two modular light fixtures 300-301 according to one embodiment of the present invention. Members 318-319 are complimentary to members 320b-321b respectively. Modules 300 and 301 may be rigidly affixed by mating members 318-319 to members 320b-321b respectively, and screwing in line 342 using holes 307, 308b and screwing in line 342 using holes 305, and 306b. Laterally 312 symmetrical form 304b stretches most of the lateral 312 width of end 332b to provide alignment of the conductive actuators (underneath and not shown) when being mated and to provide pitch 346 fixedness when affixed. The yaw 344 and roll 345 fixedness when modular light fixtures 300 and 301 are affixed, may be accomplished by the set of surfaces 326-329, and 323 mating with surfaces 336-339, and 349 as mentioned before in regard to FIG. 3B and FIG. 3C respectively. The normal axis 347 is shown in relation to light rays directed by the diffuser described before in regard to FIG. 3A. The set of surfaces 326-329, and 323 abut against surfaces 336-339, and 349 respectively in this embodiment.

A method of assembling a modular lighting system may include rigidly affixing modules 300 and 301 by mating their complimentary members to electrically couple a first plurality of LED strings of module 300 to a second plurality of LED strings of module 301. The complimentary members are located on opposite ends of each of the modules 300-301. Rigidly affixing module 300 to module 301 may also simultaneously rigidly affix module 300-301 to a support. Machine screws used in the embodiment may be long enough to engage a threaded hole or wood screws used in another embodiment may engage a plastic pilot hole in the support below (not shown).

The method may also include suspending modules 300-301 from a ceiling and providing only one drop cable from a ceiling to module 300 in order to provide power to the first and second pluralities of LED strings. The drop cable has at least two separate wires. The method may also include rigidly affixing an endcap module (e.g. module 102b of FIG. 1) to said module 300 by mating to at least one member of the third module complimentary to at least one member of module 300. The mating couples said first and second plurality of LED strings to a direct current (DC) power source. Coupling the third module to an AC power source through the DC power source illuminates the first and second plurality of LED strings.

Although pogo pins have been shown as actuators, other actuators such as spring loaded contacts may also be used as an actuator. Some conductive surfaces may be stamped. In other embodiments a deflected metal forms or assemblies may be used as the actuator. In other embodiments MEMS (microelectromechanical systems) may be used to implement the actuators. Although screws and holes have been used in the above embodiment, other connectors such as clips and snaps may be employed to affix one module to another. Although a top down assembly has been demonstrated in the above embodiment, other embodiments may be affixed along walls or floors to provide lighting.

The above description illustrates various embodiments of the present invention along with examples of how aspects of the present invention may be implemented. The above examples and embodiments should not be deemed to be the only embodiments, and are presented to illustrate the flexibility and advantages of the present invention. Based on the above disclosure, other arrangements, embodiments, implementations and equivalents will be evident to those skilled in the art and may be employed without departing from the spirit and scope of the invention.

What is claimed is:

1. A lighting system comprising:
a light fixture, said light fixture including,
a plurality of light emitting diode (LED) strings electrically coupled in a low voltage configuration, and
a housing having said plurality of LED strings disposed in the direction of a longitudinal axis of said housing, said housing including
a first member protruding from a first end of said housing and having a first set of conductive elements electrically coupled across said plurality of LED strings, and
a second member protruding from a second end of said housing and having a second set of conductive elements electrically coupled across said plurality of LED strings,
wherein said first and second members are complimentary to provide mechanical and electrical coupling between said light fixture and other fixtures without external wiring.

2. The lighting system of claim 1 wherein said first set of conductive elements is a set of conductive actuators and said second set of conductive elements is a set of conductive surfaces aligned to provide said electrical coupling.

3. The lighting system of claim 1 wherein a number of LEDs in each of said LED strings of said plurality of LED strings is limited such that a voltage across said plurality of LED strings does not exceed 42V.

4. The lighting system of claim 1 further comprising a second light fixture identical to said first light fixture coupled complimentarily to one end of said first light fixture and extending in the direction of said longitudinal axis thereby coupling a second plurality of LED strings of said second light fixture to said plurality of LED strings.

5. The lighting system of claim 1 wherein said second member includes a ridge partially circumscribing said second set of conductors and wherein said ridge is mechanically complimentary to a surface of said other fixture to provide yaw and pitch fixedness when said lighting fixture is coupled to said other fixture.

6. The lighting system of claim 1 wherein said housing includes
a second plurality of LED strings disposed in the direction of said longitudinal axis of said housing;
a third member protruding from said first end of said housing and having a third set of conductive elements; and
a fourth member protruding from said second end of said housing and having a fourth set of conductive elements,
wherein said third and fourth members are complimentary to provide additional mechanical and electrical coupling between said light fixture and said other fixtures, and
wherein said additional mechanical coupling secures lateral fixedness on said first and second ends respectively.

7. The lighting system of claim 6 wherein said second and fourth members form a continuous segment having a portion in between which may slide between two members of said other fixture to align said second and fourth sets of conductive elements.

8. The lighting system of claim 6 wherein said first and second plurality of LED strings are disposed to illuminate a region between said first and second plurality of LED strings.

9. The lighting system of claim 8 wherein said lighting fixture further comprises a light diffuser in between said first plurality of LED strings and said second plurality of LED strings, thereby redirecting a plurality of light rays toward a normal axis.

10. The lighting system of claim 9 wherein said plurality of LED strings is electrically isolated from said second plurality of LED strings to increase the likelihood of continuous light rays redirecting toward said normal axis upon partial electrical failure or partially interrupted power.

11. A method of assembling a modular lighting system comprising:
Rigidly affixing a first and second module by mating their complimentary members to electrically couple a first plurality of LED strings of said first module to a second plurality of LED strings of said second module, wherein said complimentary members are located on opposite ends of each of said first and second modules.

12. The method of claim 11 further comprising:
suspending said first and second modules from a ceiling; and
providing only one drop cable from a ceiling to said first module in order to provide power to said first and second pluralities of LED strings,
wherein said drop cable has no more than two separate wires.

13. The method of claim 11 further comprising:
rigidly affixing a third module to said first module by mating to at least one member of said third module complimentary to at least one member of said first module, wherein said mating couples said first and second plurality of LED strings to a direct current (DC) power source; and
coupling said third module to an alternating current (AC) power source, thereby enabling said DC power source to illuminate said first and second plurality of LED strings.

14. The method of claim 11 wherein said rigidly affixing a first module to said second module simultaneously rigidly affixes said first and second module to a support.

15. A light fixture comprising:
a housing;
a set of conductive actuators integrated into a first end of said housing;
a set of conductive surfaces integrated into a second end of said housing; and
a plurality of LED strings disposed within said housing and electrically coupled to said set of conductive actuators and said set of conductive surfaces,
wherein said set of conductive actuators is complimentary to said set of conductive surfaces such that a plurality of light fixtures, each identical to said light fixture, may be affixed end to end with said light fixture to provide a continuous electrical connection to illuminate said plurality of LED strings and a plurality of LED strings of each light fixture of said plurality of light fixtures.

16. The light fixture apparatus of claim 15 wherein said set of conductive actuators are a set of pogo pins.

17. The light fixture apparatus of claim 15 wherein said housing includes a first set of surfaces proximate to said set of conductive actuators that match a second set of surfaces proximate said set of conductive surfaces such that when said light fixture is affixed end to end an entire assembly of said plurality of light fixtures resists movement to yaw and roll about said first and second ends.

18. The light fixture apparatus of claim 15 wherein each string of said plurality of LED strings includes 8 LEDs coupled in series.

19. The light fixture apparatus of claim 15 wherein said housing includes a laterally symmetrical form stretching most of the lateral width of said first end to provide alignment of said conductive actuators when being mated and to provide pitch fixedness when affixed.

20. The light fixture apparatus of claim 15 further comprising a set of screws used to affix said plurality of light fixtures and said light fixture to each other after being mated end to end.
